(19) United States
(12) Patent Application Publication
(10) Pub. No.: US 2014/0002002 A1
(43) Pub. Date: Jan. 2, 2014

(54) Control Unit

(71) Applicants: Radu Barza, Weinstadt (DE); Lothar Dietl, Aalen (DE); Thomas Riemay, Korb (DE)

(72) Inventors: Radu Barza, Weinstadt (DE); Lothar Dietl, Aalen (DE); Thomas Riemay, Korb (DE)

(21) Appl. No.: 14/017,955

(22) Filed: Sep. 4, 2013

Related U.S. Application Data
(63) Continuation of application No. PCT/EP2012/050242, filed on Jan. 9, 2012.

(30) Foreign Application Priority Data
Mar. 4, 2011 (DE) 10 2011 013 884.6

(51) Int. Cl. H02P 23/00

(52) U.S. Cl. CPC H02P 23/00
USPC 318/724

(57) ABSTRACT

A control unit is disclosed for actuating an electric machine, having a first and a second voltage connection for connecting the control unit to a voltage source, a first control arrangement which is arranged between the voltage connections and is designed to electrically actuate a first electric consumer and to supply it with multi-phase current, wherein the first control arrangement has at least two electric connections for connection of the first electric consumer, wherein at least one second control arrangement is also connected in series with the first control arrangement between the voltage connections and is designed to electrically actuate a second electric consumer and to supply it with current.

### BACKGROUND OF THE INVENTION

The present invention relates to a control unit for controlling an electric machine, having a first and a second voltage connection for connecting the control unit to a voltage source, a first control arrangement which is arranged between the voltage connections and is designed to electrically control a first electric load and to supply it with multi-phase current, wherein the first control arrangement has at least two electric connections for connection of the first electric load.

The invention further relates to an electric drive having a control unit of the above-mentioned type.

The invention also relates to a power tool having an electric drive of this type.

In the prior art, electric machines are normally supplied with three-phase electric current by means of a control unit, in particular a pulse-width-modulation inverter or an inverter, in which three parallel current branches are each formed with two controllable switches, wherein the three phases U, V, W are provided at taps between the controllable switches.

DE 10 2007 040 725 A1 discloses an electric machine, which is supplied with three-phase electrical power by means of a converter, wherein the stator has a multi-phase exciter winding with three coil sets, wherein the coil sets each have two coil portions, which can be switched between a series connection and a parallel connection by means of a three-pole switching device in order to reduce the flux linkage.

A disadvantage with the known control units is that merely one coil arrangement can be controlled or supplied with current as an electric load of an electric machine, and an additional switching device is necessary to switch over between the coil portions.

On this basis, the object of the present invention is to provide an improved control unit, with which a plurality of electric loads of an electric machine can be controlled and supplied with electric current in a versatile manner with low technical effort.

### BRIEF SUMMARY OF THE INVENTION

According to one aspect of the invention a control unit of the type mentioned in the introduction is provided, wherein at least one second control arrangement is also connected in series with the first control arrangement between the voltage connections and is designed to electrically control a second electric load and to supply it with current.

In accordance with one aspect of the invention, the control unit is designed such that the consumers of the electric machine can be controlled independently, wherein, due to the series connection of the two control arrangements, both loads can be supplied with current, whereby the loads can be supplied with electrical power with low technical effort. Here, the control unit is constructed in a particularly simple manner by the series connection of the two control arrangements and can be produced with a low number of components.

It is particularly advantageous if the control unit according to the invention is used to actuate different coil systems of an electric machine, since these can thus be actuated separately from outside and the coil arrangements do not need to have a complex polarity reversal mechanism.

As will be explained in greater detail hereinafter, the control unit according to the invention provides the possibility of supplying a second coil arrangement of an electric machine separately with electric current in order to generate a rotating field that is independent of the actual rotating field. Provided the independent coil arrangements are magnetically coupled to one another, the rotating field for driving a rotor of the electric drive can thus be intensified or weakened, whereby what is known as field weakening operation or weakening operation of the electromotive force (EMF weakening operation) can be implemented and a higher no-load speed with simultaneously accordingly reduced static torque is produced.

Coil systems of this type of an electric drive can be actuated by the control unit according to the invention by simple means, wherein, in particular since the two coil systems are supplied by the same current ohmic losses in the coil systems when switching into another configuration remain the same, whereby the electric machine does not enter a thermal overload range, and the power output of the electric drive remains substantially the same in the different modes.

Due to the control unit according to the invention, a corresponding electric drive can be operated with different speed-torque characteristic curves in order to thus simulate, for example, the behavior of a motor having a mechanically switchable gear unit.

Alternatively, coils in a stator and a rotor of an electric drive can also be supplied separately with electric current. Here, both static and dynamic magnetic fields can be generated independently of one another.

An electric drive of this type is preferably used to drive a tool spindle of a power tool.

The first control arrangement preferably has a plurality of parallel current branches, each having a plurality of controllable switches, wherein the connections for controlling the first load are electrically connected to taps between the controllable switches.

The first control arrangement can thus be used by simple means as a pulse-width-modulation inverter and can supply the first electric consumer with multi-phase electrical power.

In accordance with a further development of the present invention, the second control arrangement has a plurality of parallel current branches, each having a plurality of controllable switches, wherein the second control arrangement has at least two connections for connection of the second load, said connections being connected to taps between the controllable electric switches.

Two loads can thus be supplied with multi-phase electrical power by the control unit.

The control arrangements preferably have an identical plurality of current branches.

Two identical and, where appropriate, phase-shifted multi-phase systems for actuating two loads can thus be provided.

In a preferred embodiment, the first control arrangement has three current branches, which supplies the first electric load with three-phase electrical power.

A conventional three-phase consumer can thus be supplied with electrical power by simple means.

In a further embodiment, the control arrangements each have three current branches, which supply the electric loads with three-phase electrical power.

Two three-phase consumers can thus be supplied with electrical power simultaneously, wherein the corresponding phases can have any phase shift with respect to one another.

It is furthermore preferable if the controllable switches are formed as semiconductor components, in particular as MOS field-effect transistors.

Due to these controllable switches, high voltages can be connected at a high switching speed with simultaneously low losses. Furthermore, controllable switches of this type can drive a large current, which in particular is necessary to drive electric machines.

In a further embodiment, the controllable switches are formed as IGBTs, as thyristors, or as triacs. Higher voltages can thus be connected, or higher currents can be driven.

In a specific embodiment, the first and the second control arrangement are each assigned at least one driver circuit, which controls the respective controllable switches.

Any type of controllable switches having different control characteristics can thus be used.

It is also preferable if one of the driver circuits is connected to a floating centre tap between the control arrangements, said tap forming a reference potential for the driver circuit.

Since the driver circuit requires the same reference potential as the switches to be switched, this provides a good possibility for switching accordingly the control arrangement that is not connected to ground.

Here, it is also preferable if one of the driver circuits is connected to a floating voltage source in order to supply the driver circuit with electrical power.

This provides a simple possibility for supplying the driver circuit with electrical power since the driver circuit is referenced to the same potential as to the switches to be switched.

It is also preferable if the driver circuits can be actuated by means of a control circuit.

The entire control unit can thus be controlled by means of a single control circuit, whereby machine control is enabled.

It is also preferable if one of the driver circuits, in particular the driver circuit that is connected to the centre tap, is connectable to the control circuit via floating couplers, in particular optical couplers.

Faultless transmission of control signals from the control circuit to the driver circuits is thus possible.

It also preferable if the switches of a current branch are each assigned a driver circuit.

Simple driver circuits that merely have to control two transistors can thus be used.

On the whole, a simple and cost-effective control unit is provided in accordance with the invention, with which a plurality of loads can be supplied individually with electric current, and in particular three-phase current can be provided, with which different components of three-phase machines can be supplied with electrical power.

A further advantage of the control unit according to the invention is that the phases can be changed with a very high switching speed, such that electronic commutation of an electric machine can be easily implemented.

It goes without saying that the control unit according to the invention can also be used to control different electric machines.

It goes without saying that the above-mentioned features and the features yet to be explained hereinafter can be used not only in the respective specified combination, but also in other combinations or in isolation without departing from the scope of the present invention.

### BRIEF DESCRIPTION OF THE SEVERAL VIEWS OF THE DRAWING

Exemplary embodiments of the invention are illustrated in the drawing and will be explained in greater detail in the following description. In the drawing:

FIG. 1 shows a simplified circuit diagram of a general embodiment of the control unit according to the invention;

FIG. 1a shows a simplified circuit diagram of an embodiment of the control unit with three control arrangements;

FIG. 2 shows a schematic circuit diagram of an embodiment of control arrangements, each having two current branches;

FIG. 2a shows an embodiment of the control arrangements from FIG. 2 with controllable semiconductor switches;

FIG. 3 shows a schematic circuit diagram of a further embodiment of the control unit according to the invention for controlling two coil arrangements of an electric drive;

FIG. 4 shows a further embodiment of the control unit according to the invention with controllable semiconductor switches;

FIGS. 5a to 5c show a schematic illustration of various switching states of the control unit for controlling the coil arrangements of the electric drive;

FIG. 6 shows a table for explaining the possible switching states of the control unit for actuating two coil arrangements of an electric machine for six different commutation steps;

FIG. 7 shows a schematic circuit diagram of an actuation arrangement for controlling two current branches of the control unit according to the invention;

FIG. 8 shows a highly simplified illustration of a power tool having a motor and a control unit according to the invention;

FIG. 9 shows a schematic circuit diagram of the control unit according to the invention for controlling two coil arrangements in delta connection;

FIG. 10 shows a schematic circuit diagram of the control unit according to the invention for controlling two coil arrangements which are arranged in star connection and in delta connection;

FIG. 11 shows a schematic circuit diagram of the control unit according to the invention for controlling two coil arrangements which are arranged in delta connection and in star connection.

### DETAILED DESCRIPTION OF THE INVENTION

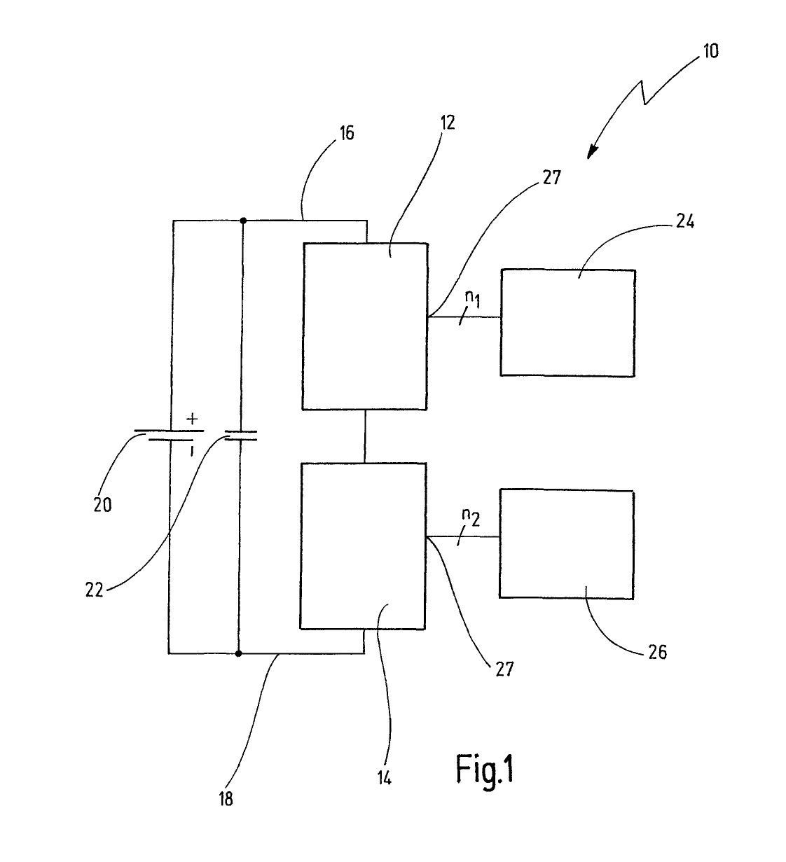

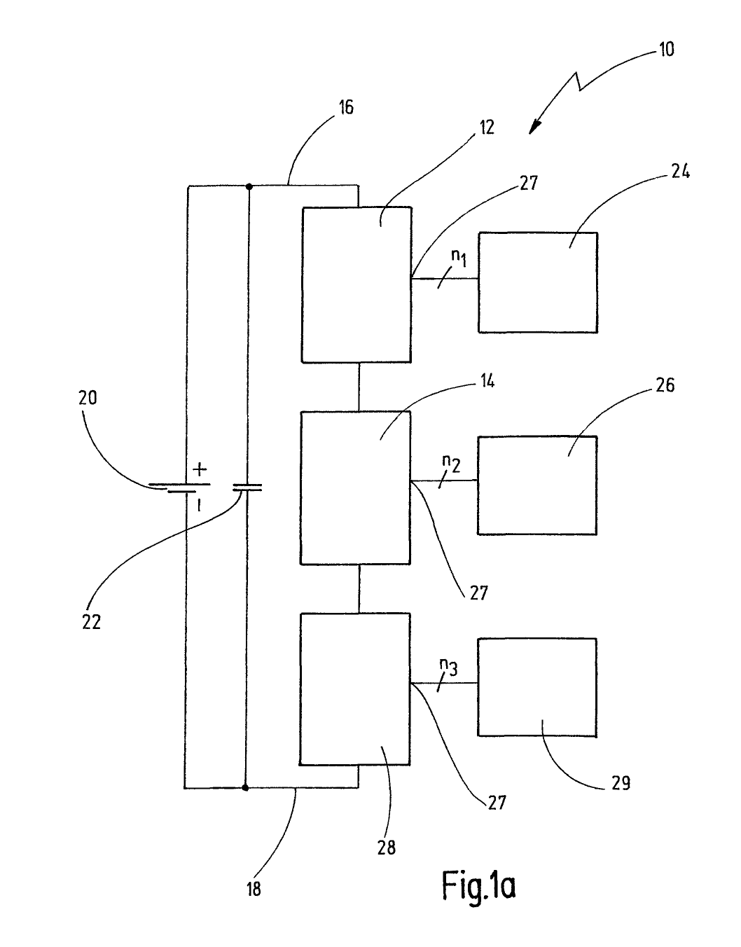

In FIG. 1, a control unit according to the invention is illustrated schematically and denoted generally by 10. The control unit 10 has a first control arrangement 12 and a second control arrangement 14. The first control arrangement 12 and the second control arrangement 14 are connected in series between two voltage connections 16, 18. The voltage connections 16, 18 are connected to an electric power supply 20. The electric power supply 20 is formed as a D.C. voltage source, such as a battery or an accumulator. A capacitor 22 is connected parallel to the D.C. voltage source 20.

The first control arrangement 12 is electrically connected to a first electric load 24. The second control arrangement 14 is electrically connected to a second electric load 26. The first control arrangement 12 is designed to supply the first electric load 24 with a current in multi-phase n₁. The second control arrangement 14 is designed to supply the second electric consumer 26 with a current in single-phase or multi-phase n₂. The first and the second control arrangement 12, 14 each have connections 27 in order to electrically connect the electric loads 24, 26.

The control arrangements 12, 14 are connected in series between the voltage connections 16, 18, such that the control arrangements 12, 14 are supplied with the same current. The control arrangements 12, 14 can electrically control the electric loads 24, 26 and supply them with multi-phase n₁, n₂ current independently of one another in each case. The control unit 10 can therefore, for example, actuate two independent coil systems of an electric machine in a multi-phase manner and can therefore supply them with current in a flexible manner and with an arbitrary phase shift with respect to one another.

An embodiment of the control unit 10 is shown in FIG. 1a. Like elements are denoted by like reference numerals, wherein merely the differences are explained here.

In addition to the control arrangements 12, 14, a further control arrangement 28 is arranged between the voltage connections 16, 18, and is designed to supply a third electric load 29 with a current in single-phase or multi-phase current n₃. The third control arrangement 28 is connected in series with the first control arrangement 12 and the second control arrangement 14. The control arrangements 12, 14, 28 are thus supplied by the same current. The embodiment of the control unit 10 illustrated in FIG. 1a can supply the three electric loads 24, 26, 29 with multi-phase n₁, n₂, n₃ electrical power independently of one another with low technical effort. The control unit 10 of FIG. 1a can, in particular, supply three independent coil systems of an electric machine with multi-phase current independently of one another with an arbitrary phase shift.

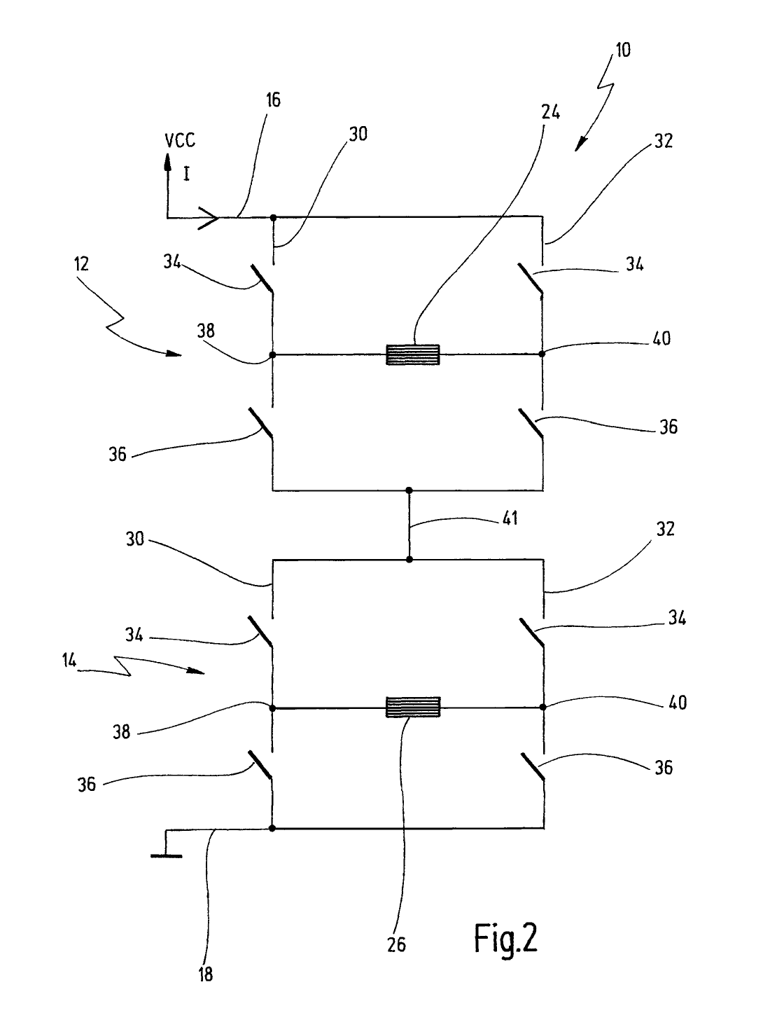

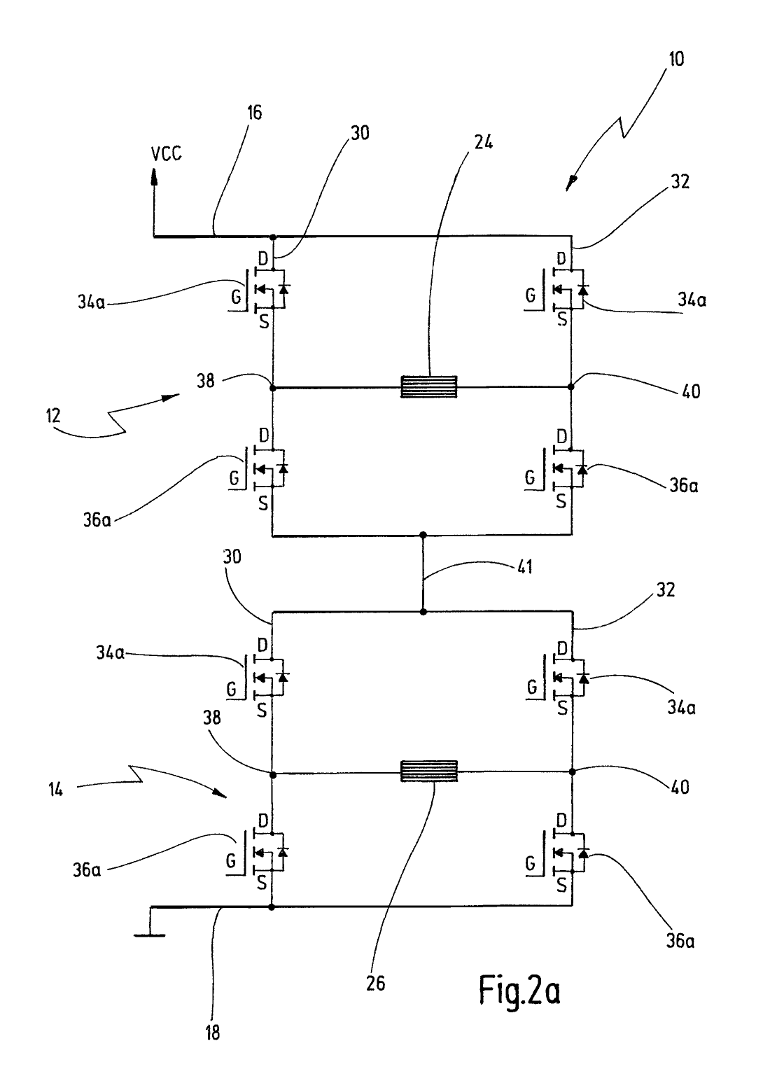

An embodiment of the control unit 10 from FIG. 1 is illustrated schematically in FIG. 2. The control arrangements, 12, 14 are electrically connected in series between the voltage connections 16, 18. The control arrangements 12, 14 are constructed identically.

The control arrangements 12, 14 each have two electric current branches 30, 32, which each have two controllable switches 34, 36. The current branches 30, 32 are formed as half-bridges. A tap 38, 40 is formed in each case between the controllable switches 34, 36 in order to connect and supply current to the respective electric loads 24, 26. The electric loads 24, 26 are each formed as a coil in this example. The electric current branches 30, 32 are electrically interconnected at their respective ends. The first control arrangement 12 and the second control arrangement 14 are electrically interconnected by means of a bridge 41, wherein the bridge 41 simultaneously forms a centre tap 41.

The controllable switches 34, 36 of the first control arrangement 12 are arranged such that, by alternately opening and closing the controllable switches 34, 36 of the two current branches 30, 32, the respective load 24, 26 is supplied with the current I in a first direction or a second direction. If the first switch 34 of the first current branch 30 is closed and at the same time the second switch 36 of the second current branch 32 is closed, and if at the same time the first switch 34 of the second current branch 32 and the second switch 36 of the first current branch 30 is opened, the current I will be provided to the respective load 24, 26 in a first direction. If the switches are closed and opened inversely, the current I will be provided to the respective consumer 24, 26 in a second direction opposite to the first direction. If both switches 34, 36 of one of the current branches 30, 32 are closed, the corresponding current branch 30, 32 is short-circuited and the respective load 24, 26 is not supplied with electrical power.

Since the first and second control arrangement 12, 14 are connected in series, the current I also flows in any case through the second control arrangement 14. If the switches 34, 36 are closed, the current branch 30, 32 is short-circuited and the current I flows directly to the ground point 18. The second consumer 26 is therefore not supplied with electrical power. If the switches 34, 36 are opened or closed in the above-described manner, the current I flows through the second consumer 26, which is thus energized and is supplied with electrical power.

At least one phase U and one phase V can be provided at the taps 38, 40 by the control unit 10 by means of the first and second control arrangement 12, 14. Since the second control arrangement 14 is connected in series with the first control arrangement 12, the same current I flows through both loads 24, 26, if both loads 24, 26 are actuated.

A simple control arrangement for actuating two electric loads can thus be provided.

A preferred embodiment of the control unit from FIG. 2 is illustrated schematically in FIG. 2a. Like elements are denoted by like reference numerals, wherein merely the differences are explained here.

The controllable switches 34, 36 of the control arrangements 12, 14 are formed as semiconductor switches 34a, 36a. The controllable switches 34a, 36a can thus be electrically controlled by simple means, wherein high switching speeds for actuating the coils 24, 26 can be implemented.

In a preferred embodiment of the invention, the electric loads 24, 26 are formed as coil systems of an electric drive or motor, wherein the first consumer 24 forms a main coil system 24 of the motor, such as a commutator coil of an electrically commutated motor, and the second consumer 26 forms a coil for generating a further magnetic field. For example, a static magnetic field can thus be generated by the coil 26, and a dynamic magnetic field or an alternating magnetic field can be generated by the coil 24. For example, the coils of a salient-pole machine can thus be controlled by the control unit 10, wherein the direction of rotation can be changed by a switchover of the control arrangement 12. Alternatively the coil 26 can also be coupled to the main coil system 24 in such a way that an intensification or weakening of the main rotating field is enabled.

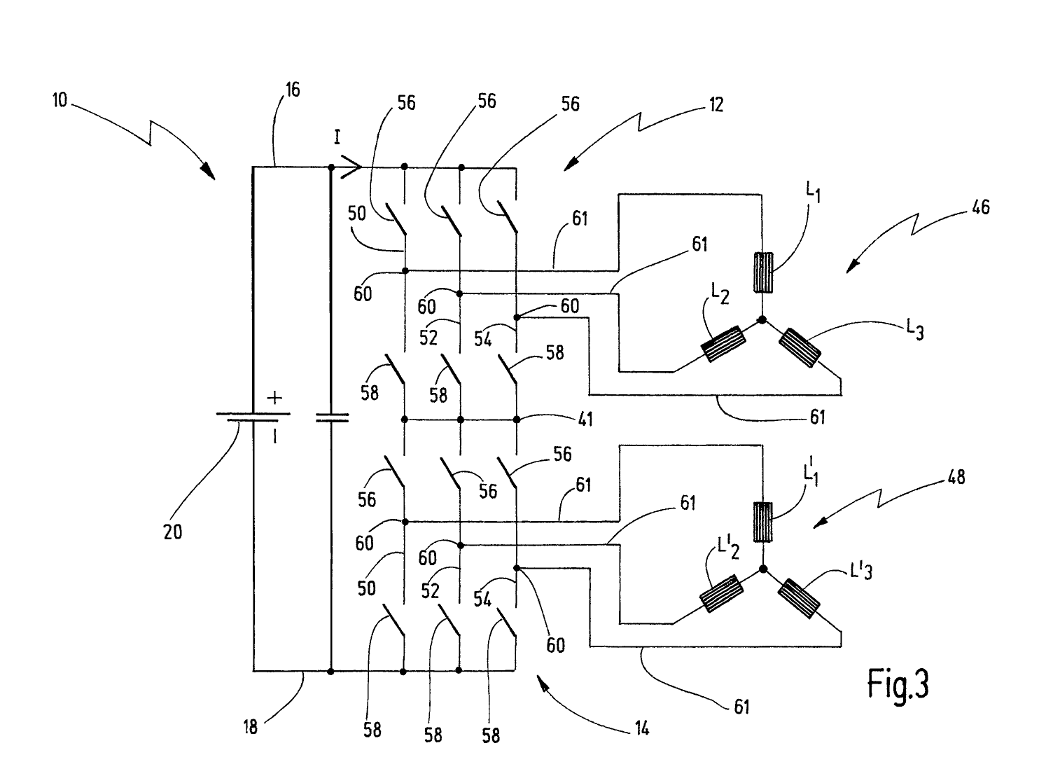

A schematic circuit diagram of an embodiment of the control unit 10 is illustrated in FIG. 3. The control unit 10 comprises the first control arrangement 12 and the second control arrangement 14, which are each connected to an electric load 46, 48 respectively, which are formed in this preferred embodiment as coil systems 46, 48 of an electric machine. The coil systems 46, 48 are each formed by three coil sets, which in this embodiment are each connected to one another in a star connection. It goes without saying that the coil sets can also be interconnected in a delta connection. The coil sets of the first coil system are denoted by L1, L2, L3. The coil sets of the second coil system 48 are denoted by L1′, L2′, L3′. The first control arrangement 12 and the second control arrangement 14 each have three current branches 50, 52, 54 in this embodiment. The current branches 50, 52, 54 are electrically interconnected at their ends, wherein the control arrangements 12, 14 are connected in series between the voltage connections 16, 18. The current branches 50, 52, 54 each have two controllable switches 56, 58. The current branches 50, 52, 54 are each formed as half-bridges. A tap 60, at which one of three phases U, V, W can be tapped, is formed between the controllable switches 56, 58 in each case.

By closing a first of the controllable switches 56 or a first of the current branches 50, 52, 54 and by closing a second of the switches 58 of another of the current branches 50, 52, 54, a voltage can be applied between the respective taps 60, and a corresponding electric line 61 can be supplied with the electric current I. Since the two control arrangements 12, 14 are connected in series between the voltage connections 16, 18, the same current I flows in this case through the two control arrangements 12, 14. If the controllable switches 56, 58 are connected such that both loads 46, 48 are supplied with current, the same current flows through both of the loads 46, 48.

The two coil systems 46, 48 of an electric machine can be controlled separately by means of the control unit 10 according to FIG. 3 and can be supplied with the same current I, wherein, by alternately closing the controllable switches 56, 58, an electronic commutation of the corresponding electric drives can be implemented.

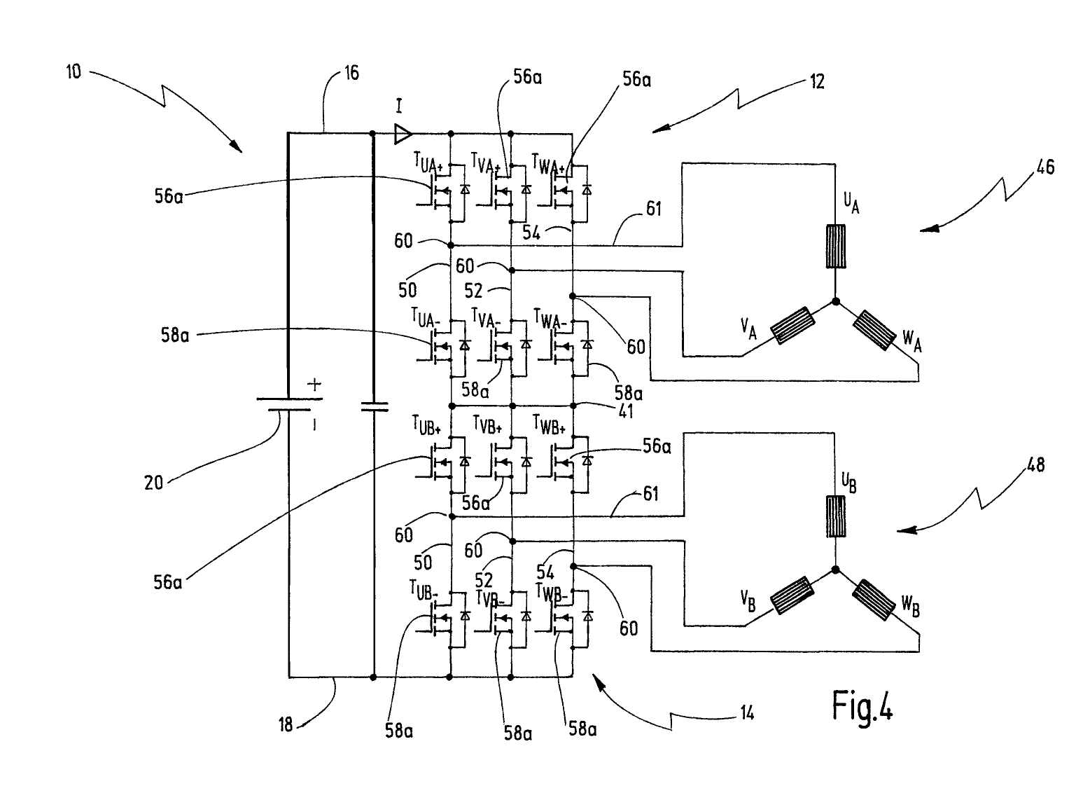

A preferred embodiment of the control unit 10 from FIG. 3 is illustrated in FIG. 4. Like elements are denoted by like reference numerals, wherein merely the differences are explained here.

The controllable switches 56, 58 are formed in this embodiment as semiconductor switches 56a, 58a. The coil systems 46, 48 each have three connections, which are denoted for the first coil system 46 by U_{A}, V_{A}, W_{A} and for the second coil system 48 by U_{B}, V_{B}, W_{B}. The taps 60 of the first control arrangement 12 are connected accordingly to the connections U_{A}, V_{A}, W_{A} of the first coil system 46, and the taps 60 of the second control arrangement 14 are accordingly connected to the connections U_{B}, V_{B}, W_{B} of the second coil system 48. The semiconductor switches 56a, 58a of the current branches 50, 52, 54 are denoted in accordance with their association with the positive potential of the voltage connection 16 or the negative potential of the voltage connection 18 and in accordance with the respective connection to the coil system 46, 48. Accordingly, the first semiconductor switch 56a of the first current branch 50, which actuates the phase U of the first coil system 46, is denoted by T_{UA+}, for example.

Since the controllable switches 56, 58 are formed by the semiconductor transistors 56a, 58a, rapid switching is possible, whereby the supply of current to the coil systems 46, 48 can be switched over with a high switching speed. This is particularly preferable with electronically commutated three-phase machines, in which a switchover has to be implemented quickly in accordance with the speed of rotation. The control arrangement 10 can thus be used for commutation of the two coil systems 46, 48.

The switching states of the controllable switches 56a, 58a for actuating the coil systems 46, 48 will be explained in greater detail hereinafter.

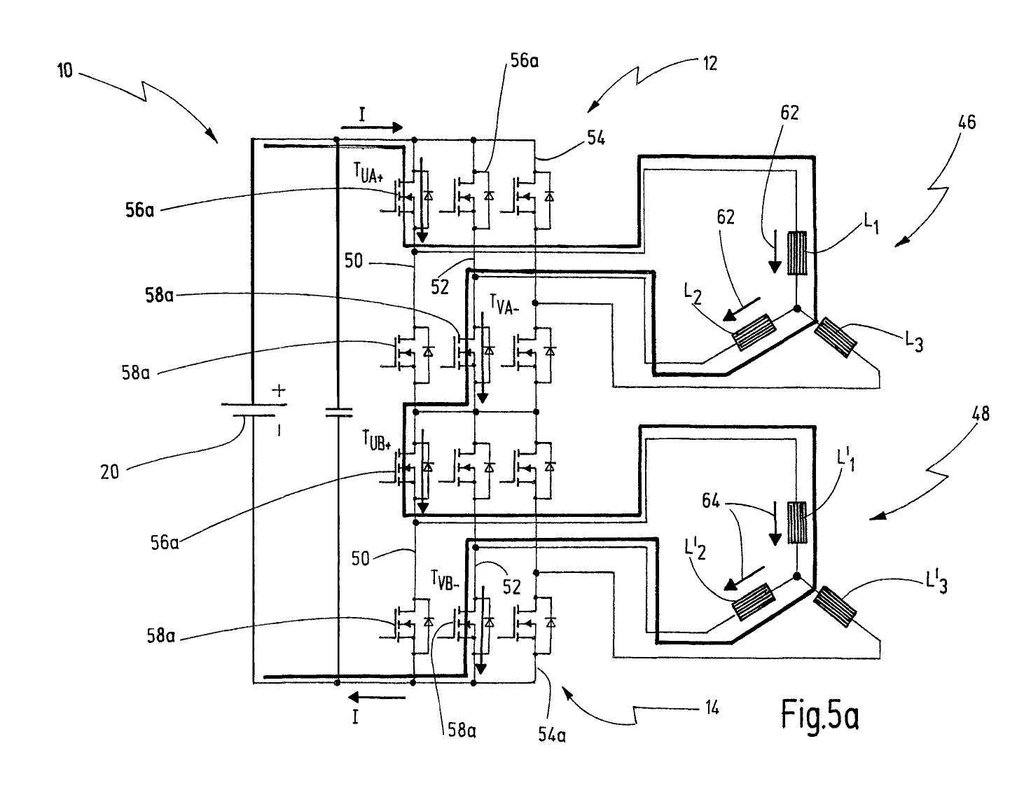

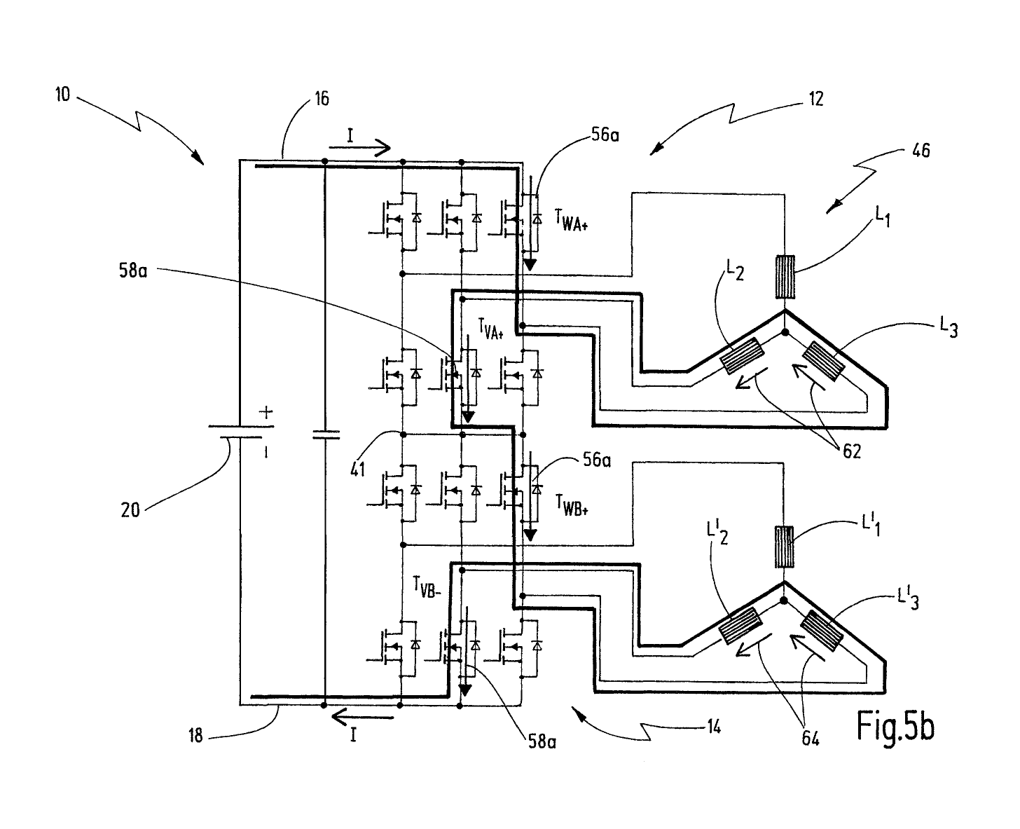

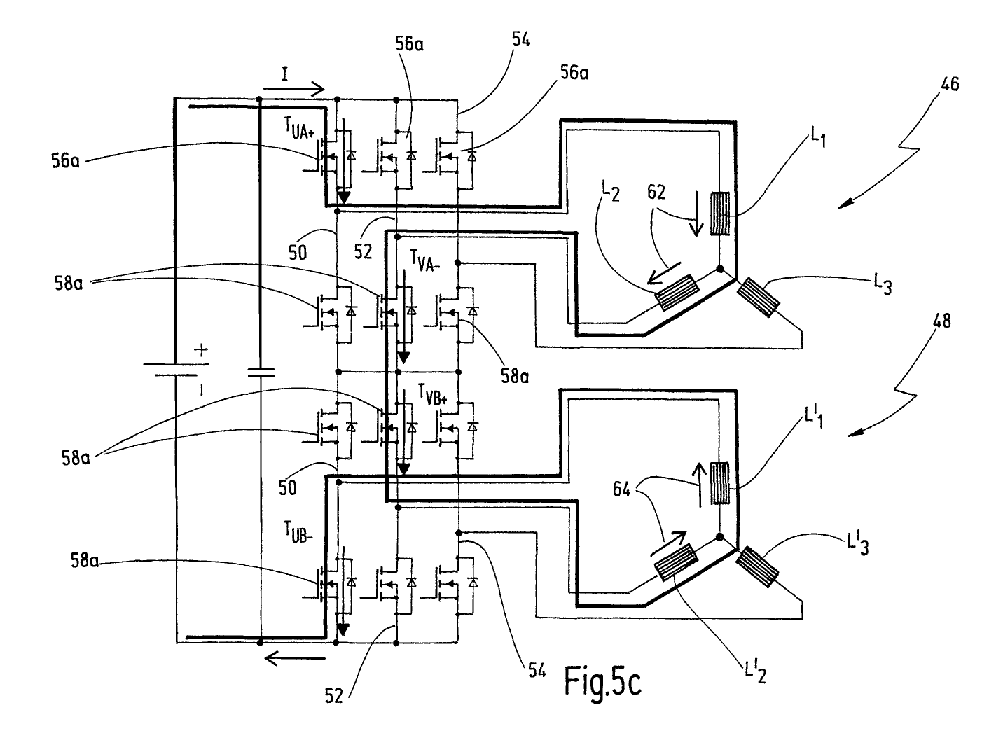

Different switching states of the controllable switches 56a, 58a in order to supply the coil systems 46, 48 differently with current are illustrated in FIGS. 5a to c. Like elements are denoted by like reference signs, wherein merely the differences are explained here.

A possible switching stage of the control unit 10 for supplying the two coil systems 46, 48 with current is illustrated schematically in FIG. 5a. Here, the first controllable switch 56a (T_{UA+}) of the first current branch 50 of the control arrangement 12 and the second controllable switch 58a (T_{VA-}) of the second current branch 52 of the controller arrangement 12 is closed or connected through, such that a voltage is applied to the coil sets L1, L2 and the current I is conducted through the corresponding coil sets L1, L2. A first rotating field 62, which corresponds to a commutation step at zero degrees, is thus produced. In the second control arrangement 14, the first controllable switch 56a (T_{UB+}) of the first current branch 50 and the second controllable switch 58a (T_{VB-}) of the second current branch 52 is closed, such that the coil sets L1′, L2′ of the second coil system 48 are provided with current accordingly and a corresponding second rotating field 64 for a commutation step of zero degrees is generated.

In FIG. 5b, a further possible switching state of the control unit 10 is shown, which provides the coil sets L2, L3 and L2′, L3′ with current and generates corresponding rotating fields for a commutation step of 60 degrees. To provide the coil systems 46, 48 with current in this way, the first controllable switch 56a (T_{WA+},T_{WB+}) of the third current branch 54 and the second controllable switch 58a (T_{VA-}, T_{VB-}) of the second current branch 52 are each closed in each of the control arrangements 12, 14. An alternative commutation step in the coil systems 46, 48 can thus be generated by simply switching over the controllable switches 56a, 58a.

In FIG. 5c, a further possible circuit of the control unit 10 is illustrated, in which the coil systems 46, 48 are supplied differently with current. The first coil arrangement system 46 is in this switching mode supplied with current in a manner identical to that in FIG. 5a, that is to say the coil sets L1 and L2 are supplied with current. The second coil system 48 is supplied with current in a direction opposite that of the first coil system 46, such that the second rotating field 64 is produced, which is directed oppositely to the first rotating field 62.

To achieve this switching mode, the controllable switches 56, 58 of the first control arrangement 12 are switched identically, as explained with reference to FIG. 5a. In order to achieve the switching state of the second coil system 48, the first controllable switch 56a (T_{VB+}) of the second current branch 52 of the second control arrangement 14 and the second controllable switch 58a (T_{UB-}) of the first current branch 50 of the second control arrangement 14 is closed. The coil sets L1′, L2′ are thus supplied with current, more specifically in a reverse direction compared to the coil sets L1, L2 of the first coil system 46.

The coil systems 46, 48 can thus be supplied with current separately by the control unit 10 in different modes, such that each of the coil systems is supplied with current in accordance with any commutation space vector.

The two coil systems 46, 48 are preferably associated fixedly with one another and are both installed either in the rotor or the stator. Here, the individual coil sets are magnetically coupled to one another such that the rotating fields 62, 64, if they are directed in the same direction, supplement one another to form a total field, or form a differential field if they are oppositely directed.

Accordingly, switching states in which the rotating fields 62, 64 are directed in the same direction and generate a total field are shown in FIGS. 5a and 5b. In FIG. 5c, a switching state is illustrated in which the rotating fields 62, 64 are oppositely directed, such that a differential field is produced. A switching state of this type is also referred to as field weakening or EMF weakening because the first rotating filed 62 is weakened by the second rotating field 64. As is shown in FIGS. 5a to 5c, the two coil systems 46, 48 can be supplied with current differently by the control unit 10 in each of the commutation steps, such that either a total field or a differential field is generated in different commutation steps. Different torque-speed characteristic curves of the corresponding electric machine can thus be produced whereby a gear-like characteristic can be simulated for example.

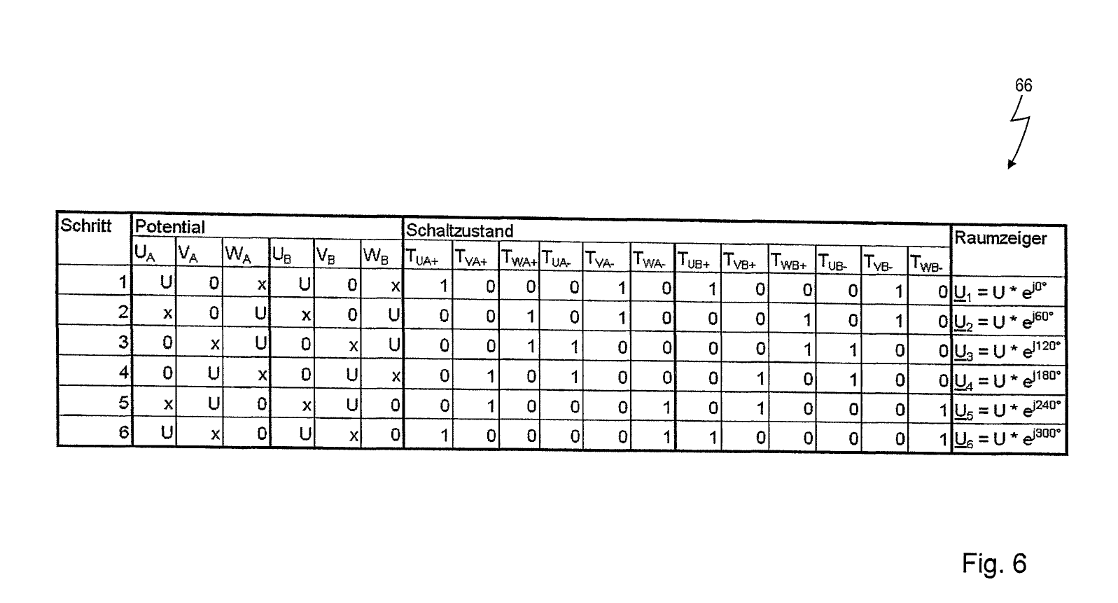

In FIG. 6, a table 66 is illustrated which illustrates switching states of the controllable switches 56a, 58a for six different commutation steps with the reference signs from FIG. 4, said switching states generating the rotating fields 62, 64 for normal operation. In other words, in switching states illustrated in FIG. 5, the rotating fields 62, 64 are in principle directed in the same direction, such that the corresponding rotating fields 62, 64 intensify to form a total field. Here, the potentials at the connections U_{A}, V_{A}, W_{A} of the first coil system 46 and at the connections U_{B}, V_{B}, W_{B} of the second coil system 48 are denoted by U or 0 for a high or lower potential respectively and by x as an undefined or floating potential. The switching states are 1 for a closed switch and 0 for an open switch. Furthermore the corresponding resultant voltage phasor is specified in polar form.

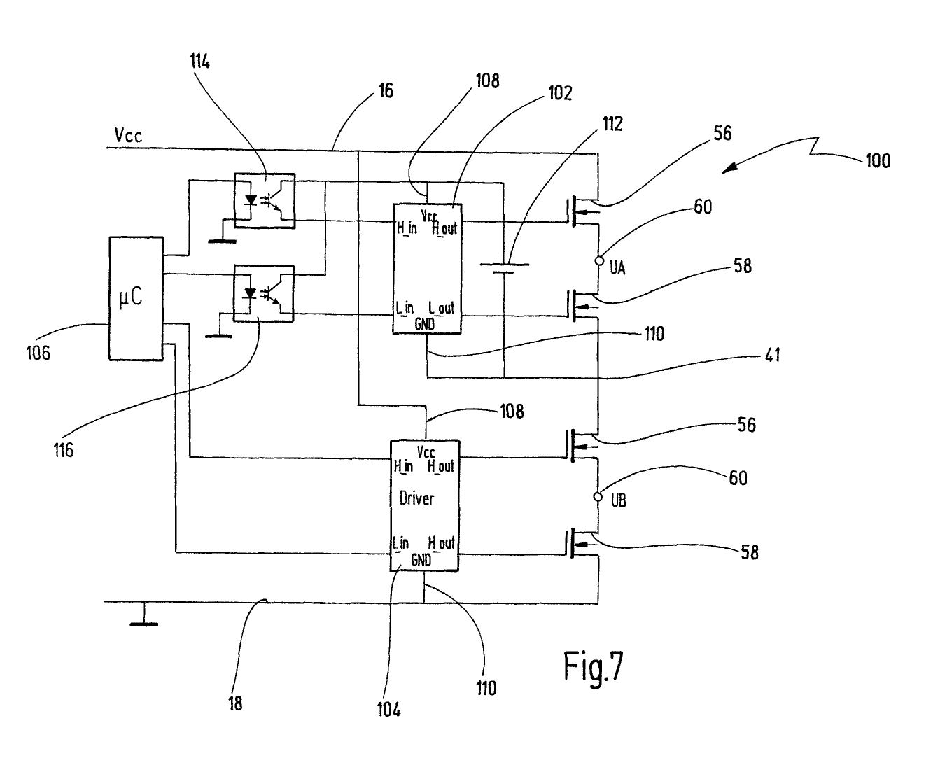

An actuation arrangement for the controllable switches 34, 36, 56, 58 according to all embodiments of the invention is illustrated in FIG. 7 and is denoted generally by 100. The actuation arrangement 100 comprises two driver circuits 102, 104, which are each connected to two controllable switches 56, 58 of one of the current branches 50, 52, 54. The driver circuits 102, 104 have two outputs, which are connected to inputs of the controllable switches 56, 58. The driver circuits 102, 104 further comprise input connections, which are connected to outputs of a controller 106, via which the driver circuits 102, 104 are controlled accordingly. The driver circuits 102, 104 further comprise a voltage connection 108 for voltage supply and a ground connection 110. The voltage connection 108 of the driver circuit 104 is connected to the voltage connection 16. The ground connection 110 of the driver circuit 104 is connected to the voltage connection 18 in order to supply the driver circuit 104 with electrical power.

Since the driver circuits 102, 104 require the same reference potential as the controllable switches 56, 58 to be driven, the ground connection 110 of the driver circuit 102 is connected to the bridge 41 or to the centre tap 41, which is formed between the respective control arrangements 12, 14. Furthermore, a floating voltage supply 112 for supplying the driver circuits 102 is provided and is connected by a negative pole to the centre tap 41 and by a positive pole to the voltage connection 108 of the driver circuit 102. The driver circuit 102 can thus be supplied with electrical power in a potential-free manner.

The input connections of the driver circuit 102 likewise have to be supplied with an input signal in a potential-free manner. The corresponding input connections of the driver circuit 102 are each connected via a potential-free coupler 114, 116 to the controller 106. A corresponding control signal can thus be transmitted from the controller to the driver circuit 102 in a floating manner. In a preferred embodiment, the floating couplers 114, 116 are formed as optical couplers.

Due to the specific embodiment of the actuation arrangement 100, two of the controllable switches 56, 58 can be driven or connected in each case, wherein the corresponding driver circuits 102, 104 are controlled via a common controller 106. Due to the potential-free voltage supply 112 and the potential-free couplers 114, 116, the controllable switches 56, 58 that do not have their reference potential at the ground connection 18 can also be controlled without difficulty.

On the whole, an effective actuation arrangement 100 for actuating the control unit 10 can thus be provided by simple means.

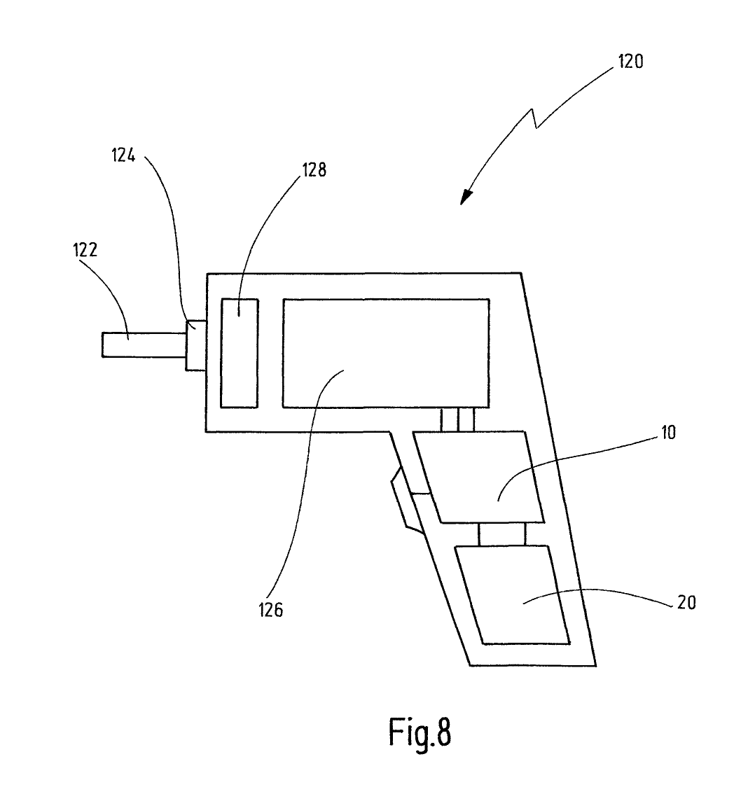

FIG. 8 shows an exemplary application of the control unit 10 according to the invention for actuating an electric motor in a power tool 120 in the form of a screwdriver. The power tool on 120 has a chuck 122 for receiving a tool, which is connected to a tool spindle 124. The power tool 120 has a motor 126, which is connected or can be connected to the spindle 124 in order to drive the chuck 122. The motor 126 is coupled to a single-stage or multi-stage gear unit 128, which can also be switchable, where appropriate. The motor 126 is actuated via the control unit 10 and is supplied with electrical power by the accumulator 20.

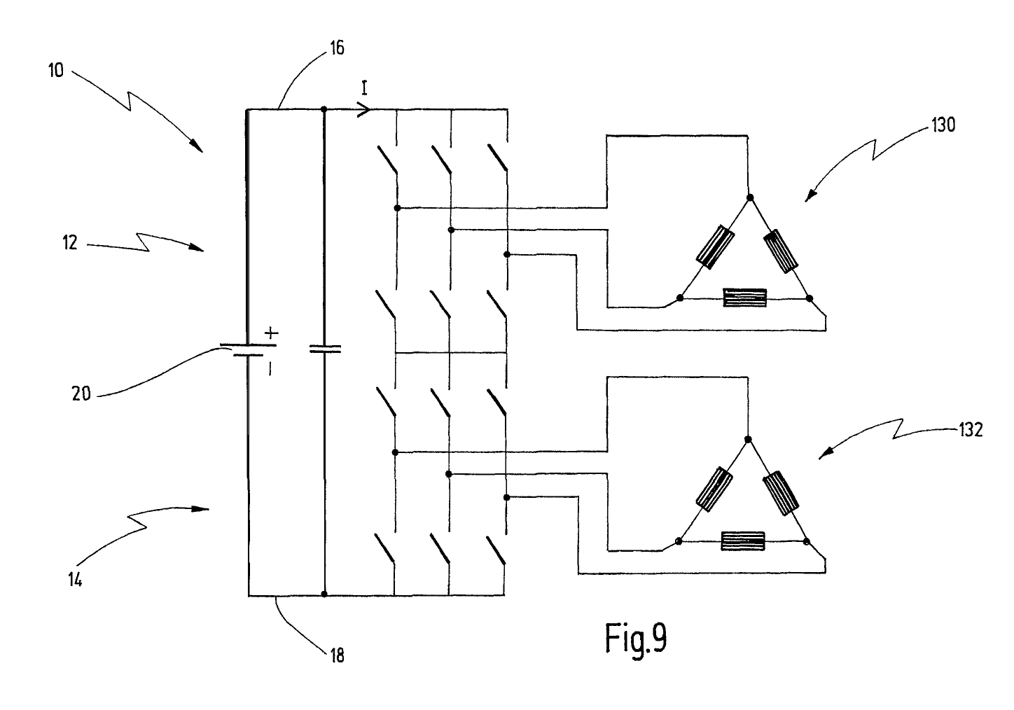

A schematic circuit diagram of the control unit 10 according to the invention for actuating two exciter coil arrangements, which are each arranged in delta connection, is illustrated in FIG. 9.

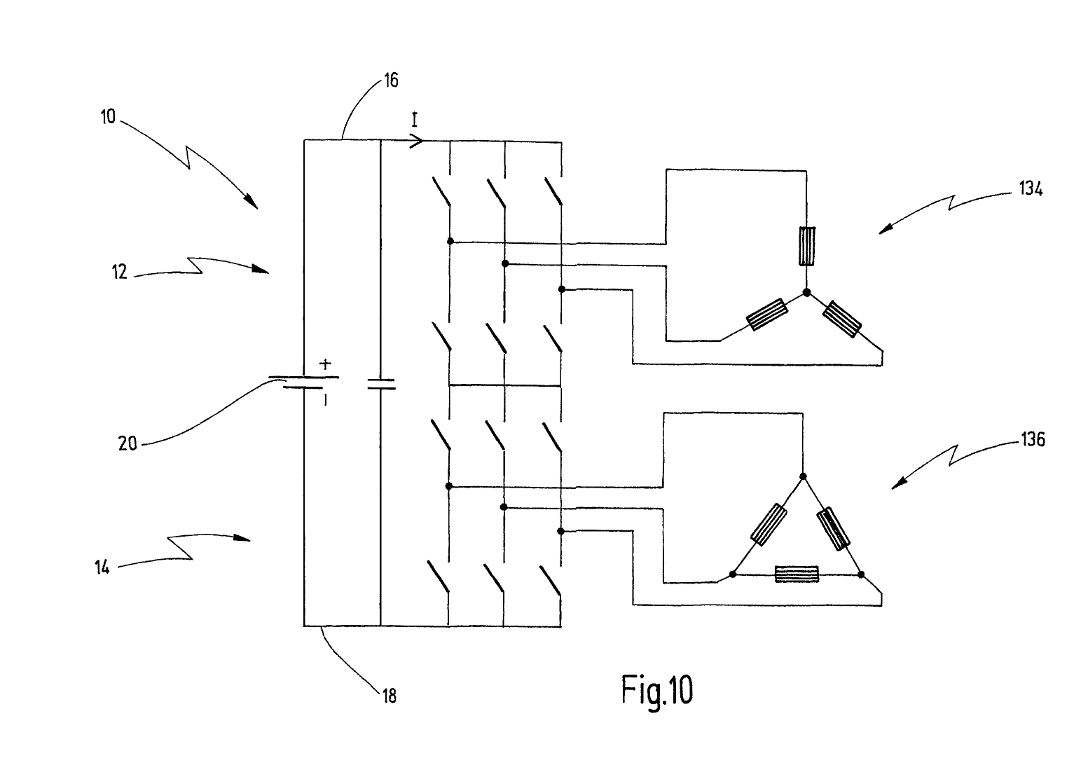

The control unit 10 illustrated in FIG. 10 is identical to the control unit 10 from FIG. 3. Like elements are denoted by like reference numerals, wherein merely the differences are presented. The control unit 10 is used to electrically actuate coil systems 130, 132 and to supply them with current. The coil systems 130, 132 are connected together in delta connection and are each provided with three-phase current by the control arrangements 12, 14.

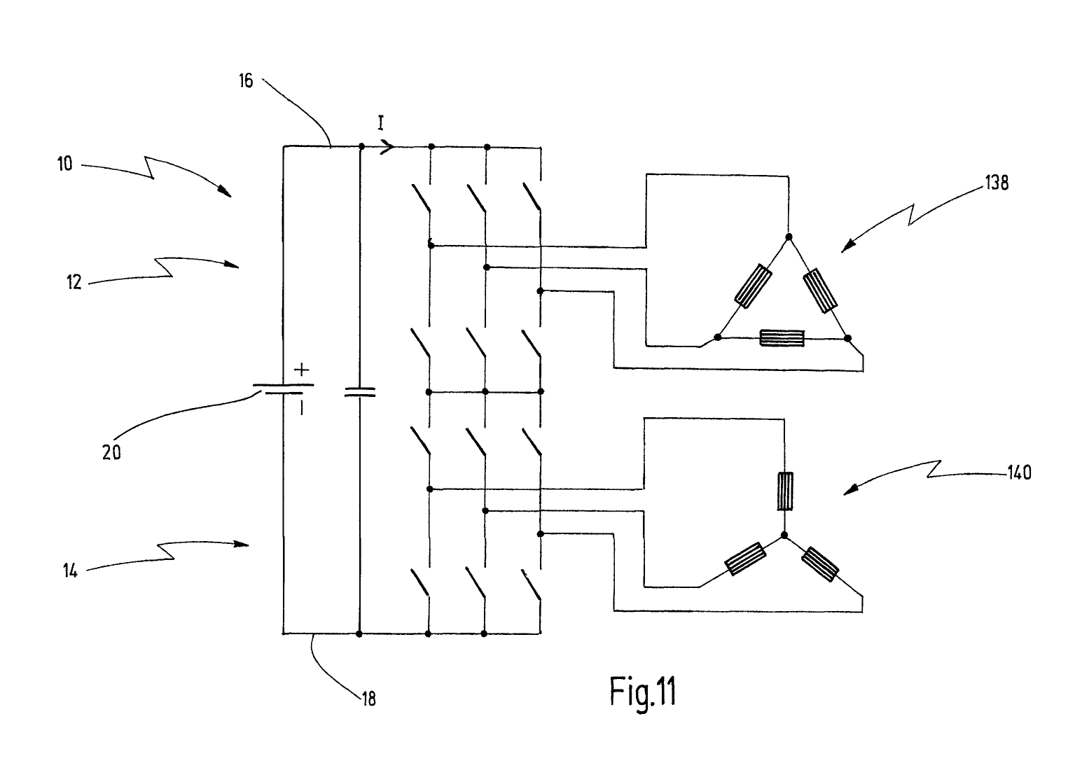

In FIG. 11, the control unit 10 according to the invention is illustrated schematically and is used to actuate coil arrangements which are arranged in star connection and in delta connection. The control unit 10 is identical to the control unit 10 from FIG. 3. Like elements are denoted by like reference numerals, wherein merely the differences are explained here. The first control arrangement 12 is connected to a first coil arrangement 134, which is arranged in star connection. The coil arrangement 12 is used to supply the coil arrangement 134 with three-phase current.

The second control arrangement 14 is connected to a second coil arrangement 136, which is arranged in delta connection. The second control arrangement 14 is used to supply the coil arrangement 136 with three-phase current.

In FIG. 12, the control unit 10 according to the invention is illustrated schematically and is used to actuate two coil arrangements which are arranged in delta connection and star connection. The control arrangement 10 is identical to the control arrangement from FIG. 3. Like elements are denoted by like reference numerals, wherein merely the differences are presented here. The first control arrangement 12 is connected to a first coil arrangement 138, which is arranged in delta connection. The first control arrangement 12 is used to supply the first coil arrangement 138 with three-phase current. The second control arrangement 14 is connected to a second coil arrangement 140, which is arranged in star connection. The second control arrangement 14 is used to supply the second coil arrangement 140 with three-phase current.

It goes without saying that the schematically illustrated control units in FIGS. 10 to 12 can also be formed with controllable switches 56a, 58a in the form of semiconductor components and in particular field-effect transistors, as is already illustrated in FIG. 4.

What is claimed is:

1. A control unit for controlling an electric machine, having a first and a second voltage connection for connecting the control unit to a voltage source, a first control arrangement which is arranged between the voltage connections and is designed to electrically control a first electric load and to supply it with multi-phase current, wherein the first control arrangement has at least two electric connections for connection of the first electric load, wherein at least one second control arrangement is also connected in series with the first control arrangement between the voltage connections and is designed to electrically control a second electric load and to supply it with current, and wherein the first and the second control arrangement are each assigned at least one driver circuit, which actuates the respective controllable switches, wherein one of the driver circuits is connected to a centre tap between the control arrangements, said centre tap forming a reference potential for the driver circuit.

2. A control unit for controlling an electric machine, having a first and a second voltage connection for connecting the control unit to a voltage source, a first control arrangement which is arranged between the voltage connections and is designed to electrically control a first electric load and to supply it with multi-phase current, wherein the first control arrangement has at least two electric connections for connection of the first electric load, wherein at least one second control arrangement is also connected in series with the first control arrangement between the voltage connections and is designed to electrically control a second electric load and to supply it with current.

3. The control unit as claimed in claim 2, wherein the first control arrangement has a plurality of parallel switches, wherein the connections for controlling the first load are connected to taps between the controllable switches.

4. The control unit as claimed in claim 2, wherein the second control arrangement has a plurality of parallel current branches, each having a plurality of controllable switches, wherein the second control arrangement has at least two connections for connection of the second load, said connections being connected to taps between the controllable switches.

5. The control unit as claimed in claim 2, wherein the control arrangements have an identical plurality of current branches.

6. The control unit as claimed in claim 2, wherein the first control arrangement has three current branches, which supply first electric consumer with at least three-phase electrical power.

7. The control unit as claimed in claim 2, wherein the control arrangements each have three current branches, which supply the electric consumers with three-phase electrical power.

8. The control unit as claimed in claim 2, wherein the controllable switches are formed as semiconductor components, in particular as MOS field-effect transistors.

9. The control unit as claimed in claim 2, wherein the first and the second control arrangement are each assigned at least one driver circuit, which actuates the respective controllable switches.

10. The control unit as claimed in claim 9, wherein one of the driver circuits is connected to a centre tap between the control arrangements, said centre tap forming a reference potential for the driver circuit.

11. The control unit as claimed in claim 9, wherein one of the driver circuits is connected to a floating voltage source in order to supply the driver circuit with electrical power.

12. The control unit as claimed in claim 9, wherein the driver circuits can be actuated by means of a control circuit.

13. The control unit as claimed in claim 9, wherein one of the driver circuits, in particular the driver circuit that is connected to the centre tap, is connectable to the control circuit via floating couplers, in particular optical couplers.

14. The control unit as claimed in claim 9, wherein the controllable switches of one of the current branches are each assigned a driver circuit.

15. An electric drive having a control unit as claimed in claim 1, which can be connected to a coil arrangement of the electric machine for driving the drive.

16. A power tool comprising an electric drive as claimed in claim 15, which can be coupled to a tool spindle in order to drive the tool.
